(19) United States
(12) Patent Application Publication
(10) Pub. No.: US 2018/0115914 A1
(43) Pub. Date: Apr. 26, 2018

(54) COMMUNICATION SYSTEM, COMMUNICATION DEVICE AND METHOD

(71) Applicant: FUJITSU LIMITED, kAWASAKI-SHI (JP)

(72) Inventors: Kazuyuki OZAKI, Yokohama (JP); Shunsuke Fujio, Kawasaki (JP)

(73) Assignee: FUJITSU LIMITED, Kawasaki-shi (JP)

(21) Appl. No.: 15/726,039

(22) Filed: Oct. 5, 2017

(30) Foreign Application Priority Data
Oct. 20, 2016 (JP) 2016-206364

(51) Int. Cl. H04W 16/28; H04L 12/24; H04W 72/04; H04W 48/16

(52) U.S. Cl. CPC H04W 16/28; H04L 41/0654; H04W 88/02; H04W 48/16; H04W 72/046

(57) ABSTRACT

A communication system includes a first communication device, and a second communication device, wherein the first communication device includes a first memory, and a first processor coupled to the first memory and configured to detect that a first communication between the first communication device and a terminal device has been cut off, specify, when the first communication has been cut off, a first direction from the second communication device to the terminal device, and transmit, to the second communication device, direction information indicating the first direction and a transmission request requesting a transmission of data, and the second communication device includes a second memory, and a second processor coupled to the second memory and configured to receive the direction information and the transmission request, and transmit, based on the direction information and the transmission request, the data to the terminal device.

### CROSS-REFERENCE TO RELATED APPLICATION

This application is based upon and claims the benefit of priority of the prior Japanese Patent Application No. 2016-206364, filed on Oct. 20, 2016, the entire contents of which are incorporated herein by reference.

### FIELD

The embodiments discussed herein are related to a communication system, a communication device and a method.

### BACKGROUND

In recent years, in a wireless communication system, there has been an increased demand for ultra-high speed transmission. As a method for realizing ultra-high speed transmission, there is a method in which a broadband signal is used. For example, an international standard in which a wireless communication is performed using a frequency in a 60 GHz band, which is higher than that of a microwave, has been disclosed. However, in a communication using such a high frequency band, a propagation loss is increased, and therefore, there is a case where a technology of compensating for the propagation loss is used. As an example of the technology, there is a technology in which a beam is controlled using a plurality of antennas to increase an antenna gain. Reference documents include IEEE Std 802.11ad-2012: IEEE Standard for Information technology—Telecommunications and information exchange between systems—Local and metropolitan area networks—Specific requirements, Part 11: Wireless LAN Medium Access Control (MAC) and Physical Layer (PHY) Specifications, IEEE, New York, N.Y., USA, Dec. 28, 2012, and Status of project IEEE 802.11ay: Enhanced Throughput for Operation in License-Exempt Bands above 45 GHz, Jul. 19, 2017.

### SUMMARY

According to an aspect of the invention, a communication system includes a first communication device, and a second communication device, wherein the first communication device includes a first memory, and a first processor coupled to the first memory and configured to detect that a first communication between the first communication device and a terminal device has been cut off, determine a direction from the second communication device to the terminal device when the first communication has been cut off, and transmit, to the second communication device, direction information indicating the direction and a transmission request requesting a transmission of data, and the second communication device includes a second memory, and a second processor coupled to the second memory and configured to receive the direction information and the transmission request, and transmit the data to the terminal device based on the direction information and the transmission request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration of a wireless communication system;

FIG. 2 is a block diagram illustrating a hardware configuration of AP and a terminal;

FIG. 3 is a block diagram illustrating a functional configuration of AP when a terminal does not execute beam forming (BF);

FIG. 4 is a block diagram illustrating a functional configuration of AP when a terminal executes beam forming (BF);

FIG. 5 is a block diagram illustrating a functional configuration of a terminal when a terminal executes beam forming (BF);

FIG. 6A is a flowchart illustrating an operation of AP when a terminal does not execute beam forming (BF);

FIG. 6B is a flowchart illustrating retransmission request signal transmission processing that is executed by AP when a terminal does not execute beam forming (BF);

FIG. 7A is a flowchart illustrating an operation of AP when a terminal executes beam forming (BF);

FIG. 7B is a flowchart illustrating retransmission request signal transmission processing that is executed by AP when a terminal executes beam forming (BF);

FIG. 8 is a flowchart illustrating an operation of a terminal when the terminal executes beam forming (BF);

FIG. 9 is a diagram illustrating an example of a format of a packet that is transmitted to a terminal by AP;

FIG. 10 is a diagram illustrating an example of a format of a retransmission request packet that is transmitted by AP to anther AP; and

FIG. 11 is a diagram illustrating a method for calculating a beam direction of a terminal after AP switching.

### DESCRIPTION OF EMBODIMENTS

Even though an antenna gain has been increased by beam control as described above, for example, there is a case where, when a communication path between an antenna of an access point (AP) and a terminal is cut off by a human body or a shielding object, a wireless communication is cut off. In this case, retransmission processing of retransmitting a packet or the like is executed and, in an ultra-wide band communication, such as a millimeter wave communication, because a time which it takes to perform a packet transmission is short, a shielding time in which a wireless communication is cut off by the human body or the shielding object is very long relative to a packet transmission time accordingly. Therefore, an overhead (a system load) accompanied with a packet retransmission is very large. As a result, a throughput of a wireless communication system might be reduced.

In view of the forgoing, a technology disclosed herein has been devised and it is an object of the present disclosure to provide a communication control system, a communication control device, a communication terminal, and a communication control method which are capable of reducing reduction in throughput.

Embodiments of a communication control system, a communication control device, a communication terminal, and a communication control method that are disclosed herein will be described in detail below with reference to the accompanying drawings. Note that the communication control system, the communication control device, the communication terminal, and the communication control method that are disclosed herein are not limited to the embodiments below.

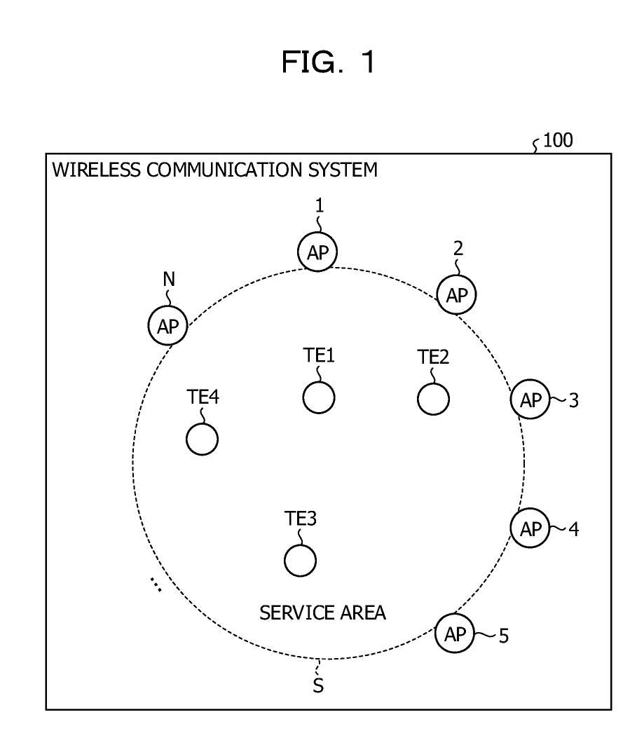

FIG. 1 is a diagram illustrating an entire configuration of a wireless communication system 100. As illustrated in FIG. 1, the wireless communication system 100 includes AP1 to APN (N is an integer of 2 or more) and terminals TE1 to TE4 that are located in a service area S. Note that each of the number of APs and the number of terminals is not limited to the number of those illustrated in FIG. 1. Each of AP1 to APN directly performs a communication with the terminals TE1 to TE4 in the service area S but a communication between the terminals TE1 to TE4 is not performed. Also, each of AP1 to APN performs a beam search between each of AP1 and APN and the corresponding one of AP1 and APN before performing a communication with the corresponding one of the terminals TE1 to TE4 to recognize the locations (beam directions) of AP1 to APN and distances between AP1 to APN.

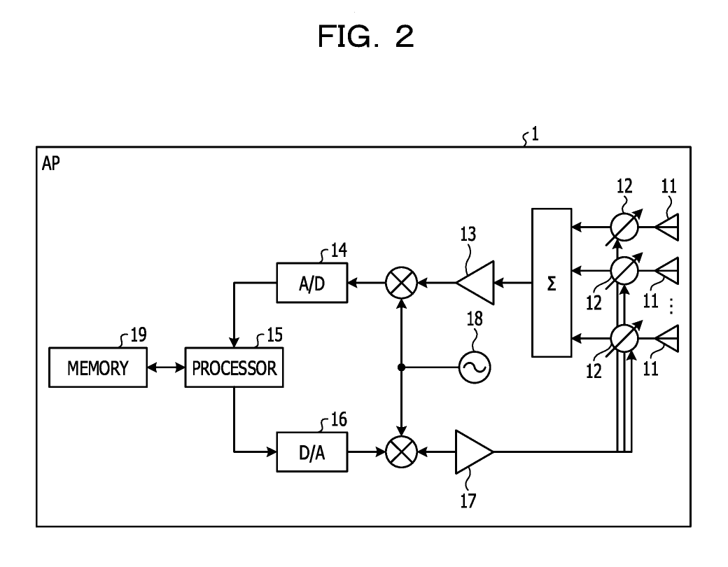

FIG. 2 is a block diagram illustrating a hardware configuration of AP1 and the terminal TE1. As illustrated in FIG. 2, AP1 includes transmission and reception antennas 11, phase controllers 12, an amplifier 13, an analog-to-digital converter 14, a processor 15, a digital-to-analog converter 16, an amplifier 17, a transmitter 18, and a memory 19. The above-described component elements are coupled to one another such that uni-directional or bidirectional input and output of a signal or a packet is enabled.

The transmission and reception antenna 11 transmits a signal that is data as a radio wave toward surroundings and receives a signal that is data as a radio wave. The phase controller 12 controls the phase of a signal that is transmitted and received by each transmission and reception antenna 11. The amplifier 13 is an amplifier that amplifies a signal that has been received by the transmission and reception antenna 11. The analog-to-digital converter 14 converts an analog signal that has been amplified by the amplifier 13 to a digital signal. The processor 15 is a processing unit that performs entire processing of AP1 and, for example, executes a calculation of transmission power using a signal that has been input from the analog-to-digital converter 14. The digital-to-analog converter 16 converts a signal that has been input from the processor 15 to an analog signal. The amplifier 17 amplifies the analog signal that has been converted by the digital-to-analog converter 16 such that the analog signal has a transmission power value that has been notified from the processor 15. Thereafter, the phase controller 12 controls the phase of a signal that has been transmitted from each transmission and reception antenna 11, and the each transmission and reception antenna 11 transmits the signal that has been amplified by the amplifier 17 to a destination terminal. The transmitter 18 outputs a continuous-wave alternating-current signal. The received signal is converted to a base band signal using the output. The memory 19 stores a threshold (for example, a threshold M of the number of times of signal transmission i, which will be described later) or the like, which has been determined in advance.

A configuration of the AP1 has been described above, each of the terminals TE1 to TE4 has, in terms of hardware, a similar configuration to the configuration of AP1, which has been described above, and therefore, the illustration and detailed description thereof will be omitted. Also, the configuration of AP1 has been representatively described, and the configuration of each of the other AP2 to APN is similar to the configuration of AP1. Therefore, common component elements are denoted by reference symbols that have the same end character and the illustration and detailed description thereof will be omitted.

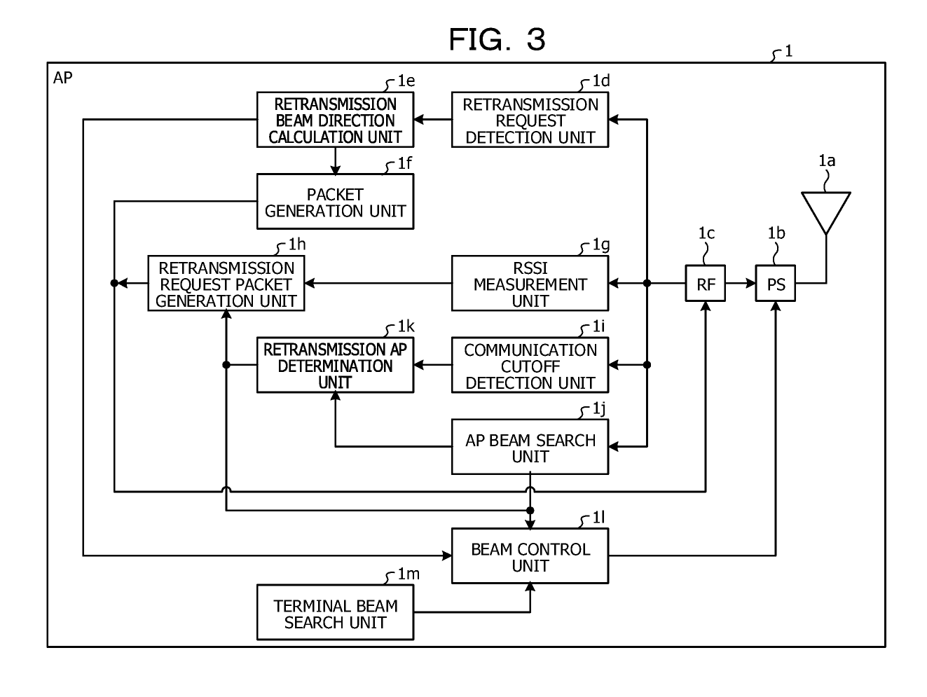

Subsequently, with reference to FIG. 3 to FIG. 5, functional configurations of AP1 and the terminal TE1 will be described. Specifically, for AP1, a functional configuration when a terminal does not execute beam forming (BF) and a functional configuration when a terminal executes BF will be separately described.

FIG. 3 is a block diagram illustrating a functional configuration of AP1 when the terminal TE1 does not execute BF. As illustrated in FIG. 3, AP1 includes an antenna 1a, a phase shifter (PS) unit 1b, a radio frequency (RF) unit 1c, a retransmission request detection unit 1d, a retransmission beam direction calculation unit 1e, a packet generation unit 1f, a received signal strength indication (RSSI) measurement unit 1g, a retransmission request packet generation unit 1h, a communication cutoff detection unit 1i, an AP beam search unit 1j, a retransmission AP determination unit 1k, a beam control unit 1l, and a terminal beam search unit 1m. The above-described component elements are coupled to one another such that uni-directional or bidirectional input and output of a signal or a packet is enabled.

The AP beam search unit 1j determines a beam direction when a beam search between APs is performed. The beam control unit 1l calculates the phase of the antenna 1a such that a beam is directed in the beam direction that has been notified from the AP beam search unit 1j. The PS unit 1b actually controls the phase to transmit a signal and receives a beam search signal that has been transmitted from each of AP2 to APN. The RF unit 1c converts the beam search signal to a base band (BB) signal. The AP beam search unit 1j detects the beam direction of each of AP2 to APN.

The communication cutoff detection unit 1i detects, based on the number of times of signal transmission from self AP1 to the terminal TE1, a cutoff of a communication. If a communication cutoff has been detected by the communication cutoff detection unit 1i, the retransmission AP determination unit 1k determines another AP that performs packet retransmission, based on the beam direction at a current time point and a search result of a beam search performed by the AP beam search unit 1j.

In determining retransmission AP, for example, the retransmission AP determination unit 1k selects AP (for example, AP5 in FIG. 1) the beam direction of which is opposite to the beam direction from self AP1 to the terminal. As another option, as another selection method, a method in which the retransmission AP determination unit 1k selects AP (for example, AP3 in FIG. 1) that is located in a normal direction of the beam direction from self AP1 to the terminal TE1 may be employed. Furthermore, a method in which the retransmission AP determination unit 1k selects AP, among the other AP2 to APN, which is not communicating with any one of the terminals, may be employed.

The retransmission request packet generation unit 1h generates a retransmission request packet to another AP, based on AP that has been determined by the retransmission AP determination unit 1k. At this time, the retransmission request packet generation unit 1h notifies the retransmission beam direction of another AP that requests retransmission by the retransmission request packet. In this case, it is assumed that self AP is AP1, AP that receives a retransmission request packet is AP2, an RSSI value between AP1 and the terminal TE1 is RSSI₀, an RSSI value between AP1 and AP2 is RSSI₁, the current beam direction of AP1 is φ, the beam direction between AP1 and AP2 is θ. In this case, the transmission beam direction ω of a retransmission packet of AP2 may be represented by Expression 1 as follows.

$$\begin{matrix}[ Expression 1 ] & \\ cos ω = \frac{y + x cos ( θ - φ )}{\sqrt{{x}^{2} + {y}^{2} + 2 xy cos ( θ - φ )}} & ( 1 )\end{matrix}$$

Note that x is a distance between AP1 and the terminal TE1 and may be represented by Expression 2 as follows.

[Expression 2]

x=f(RSSI₀) (2)

Similarly, y is a distance between AP2 and the terminal TE1 and may be represented by Expression 3 as follows.

[Expression 3]

y=f(RSSI₁) (3)

Also, f(P) in Expression 2 and Expression 3 above is a function used for calculating each of the above-described distances from the corresponding one of the RSSI values. Using an expression defined in a document [11-09-0334-08-00ad-channel-models-for-60-ghz-wlan-systems.doc], f(P) may be represented by Expression 4 as follows.

$$\begin{matrix}[ Expression 4 ] & \\ f ( P ) = {10}^{\frac{{P}_{tx} + {P}_{i} - P - 32.5 - 20 lo {g}_{10} ( {f}_{RF} )}{20}} & ( 4 )\end{matrix}$$

In this case, Pₜₓ is a transmission power value, Pᵢ is an antenna gain, and f_{RF} is a carrier frequency. Although Pₜₓ and Pᵢ may be measured in advance, Pₜₓ and Pᵢ may be exchanged as control information with another AP or the like.

AP1 directs a beam in a direction in which another PA that has been determined by the retransmission AP determination unit 1k is located, controls the phase of PS by the beam control unit 1l, based on the direction of the corresponding AP for which the AP beam search unit 1j has searched, and transmits a packet that has been generated by the retransmission request packet generation unit 1h from the antenna 1a. Also, AP1 determines, by the retransmission request detection unit 1d, whether or not a retransmission request signal from another AP has been received and, if the retransmission request signal has been received, calculates, by the retransmission beam direction calculation unit 1e, a beam direction from retransmission beam direction information included in the retransmission request signal. Furthermore, AP1 controls, by the beam control unit 1l, PS of the antenna 1a at the time of retransmission packet transmission, generates, by the packet generation unit 1f, a retransmission packet, and transmits the signal thereof. If, after switching AP to another AP, AP1 receives an ACK signal from the terminal TE1, thereafter, AP that has received the retransmission request signal performs a communication with the terminal TEL

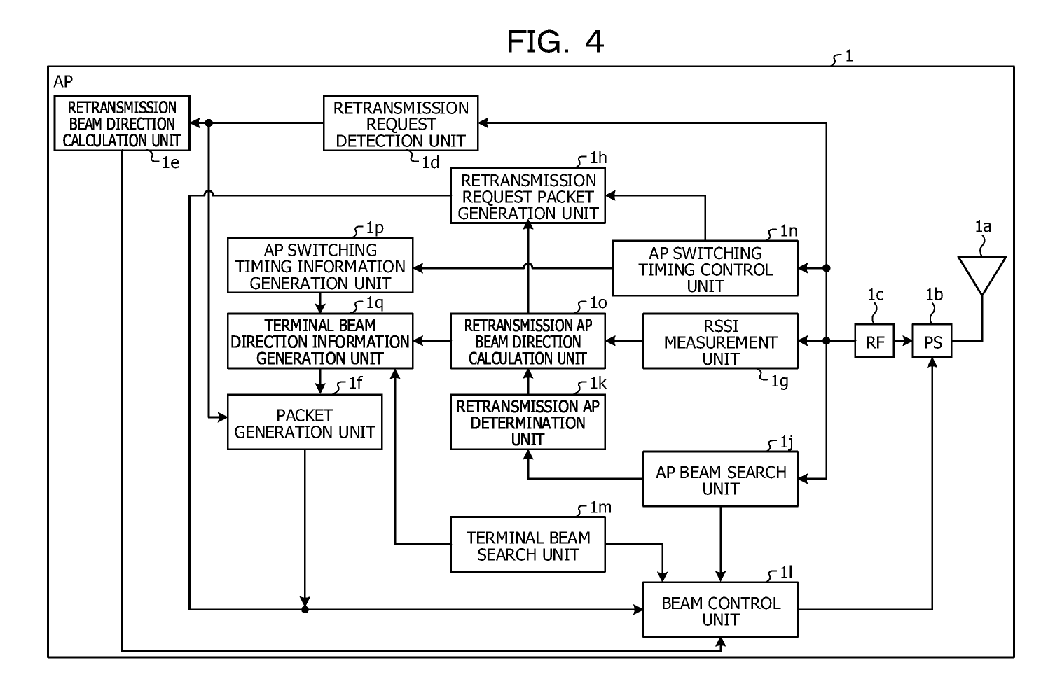

FIG. 4 is a block diagram illustrating a functional configuration of AP1 when the terminal TE1 executes BF. A functional configuration of AP1 when the terminal TE1 executes BF is similar to the functional configuration of AP1 when the terminal TE1 does not execute BF, which has been illustrated in FIG. 3, in a major part. Therefore, common component elements are denoted by the same reference symbol and the detailed description thereof will be omitted. AP1 when the terminal TE1 executes BF newly includes an AP switching timing control unit 1n, a retransmission AP beam direction calculation unit 1o, an AP switching timing information generation unit 1p, and a terminal beam direction information generation unit 1q, which will be described later.

The AP beam search unit 1j determines a beam direction when a beam search between APs is performed. The beam control unit 1l calculates the phase of the antenna 1a such that a beam is directed in a beam direction notified from the AP beam search unit 1j. The PS unit 1b actually controls the phase to transmit a signal and receives a beam search signal that has been transmitted from each of AP2 to APN. The RF unit 1c converts the beam search signal to a BB signal. The AP beam search unit 1j detects the beam direction of each of AP2 to APN. Similarly, in the terminal beam search unit 1m, a beam direction when performing a communication with the terminal TE1 is determined.

The retransmission request detection unit 1d detects a retransmission request signal that has been transmitted from another AP. When the retransmission beam direction calculation unit 1e detects the retransmission request signal, the retransmission beam direction calculation unit 1e calculates a beam direction from retransmission beam direction information included in the retransmission request signal. The beam control unit 1l controls PS of an antenna at the time of retransmission packet transmission. The packet generation unit 1f generates a transmission packet and transmits the signal thereof.

The AP switching timing control unit 1n controls a timing of switching AP. The retransmission AP determination unit 1k switches AP, based on a RSSI value that has been measured by an RSSI measurement unit 1g and a search result of a beam search performed by the AP beam search unit 1j, and selects AP to which a retransmission packet is transmitted. The retransmission AP beam direction calculation unit 1o calculates a beam direction when another AP transmits a retransmission packet to the terminal TE1, based on a selection result of selection performed by the retransmission AP determination unit 1k. The AP switching timing information generation unit 1p generates information that indicates a timing of switching AP, based on an input from the AP switching timing control unit 1n. The terminal beam direction information generation unit 1q calculates the beam direction of the terminal TE1 after AP switching, based on an input from the retransmission AP beam direction calculation unit 1o, and generates information that indicates a result of the calculation. The packet generation unit 1f inserts each of information generated by the AP switching timing information generation unit 1p and information generated by the terminal beam direction information generation unit 1q in control information, and thereby, generates a packet the destination of which is the terminal TE1. The beam control unit 1l controls, based on a search result of a beam search performed by the terminal beam search unit 1m, PS such that a beam is directed in a direction toward the terminal TE1 that is a transmission target, and transmits the packet.

When the timing of switching AP comes, the retransmission request packet generation unit 1h generates a retransmission request packet that is transmitted to AP that has been determined by the retransmission AP determination unit 1k. The retransmission request packet includes ID information of the terminal TE1 to which the retransmission packet is transmitted and beam direction information when the retransmission packet that has been calculated by the retransmission AP beam direction calculation unit 1o in the control information. AP1 directs a beam in a direction toward AP2 that is a retransmission request destination, based on a search result of a beam search performed by the AP beam search unit 1j, and controls, by the beam control unit 1l, PS1b to transmit the retransmission request packet generated by the retransmission request packet generation unit 1h.

A functional configuration of AP1 has been representatively described above, and a functional configuration of each of the other AP2 to APN is similar to the functional configuration of AP1. Therefore, common component elements are denoted by the same reference symbol and the illustration and description thereof will be omitted.

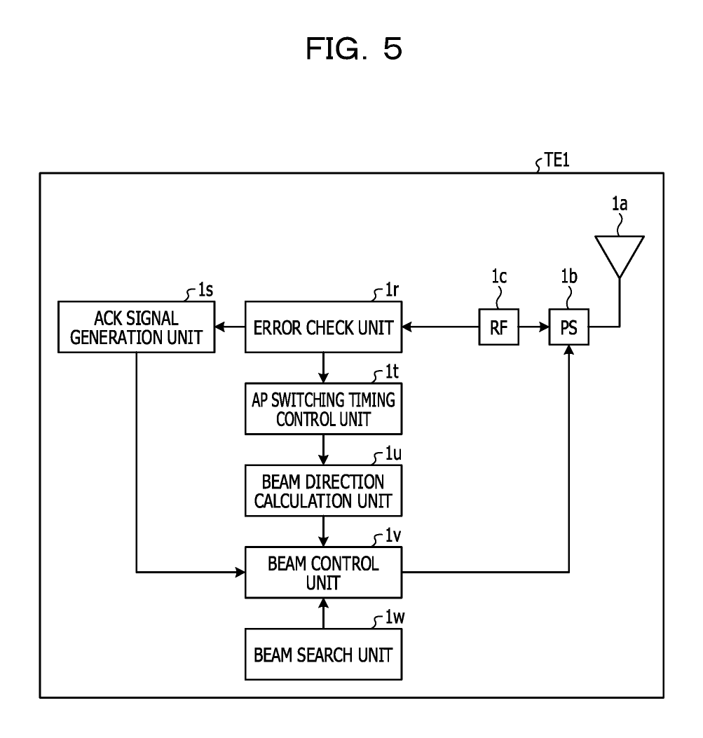

FIG. 5 is a block diagram illustrating a functional configuration of the terminal TE1 when the terminal TE1 executes BF. As illustrated in FIG. 5, the terminal TE1 includes an antenna 1a, a PS unit 1b, an RF unit 1c, an error check unit 1r, an ACK signal generation unit 1s, an AP switching timing control unit 1t, a beam direction calculation unit 1u, a beam control unit 1v, and a beam search unit 1w. The above-described component elements are coupled to one another such that uni-directional or bidirectional input and output of a signal or a packet is enabled.

The beam search unit 1w determines a beam direction when a beam search in which the direction of AP is detected is performed. The beam control unit 1v calculates the phase of the antenna 1a such that a beam is directed in a beam direction that has been notified from the beam search unit 1w, actually controls, by the PS unit 1b, the phase, and transmits a signal. Also, when the terminal TE1 receives a beam search signal that has been transmitted from each of AP1 to APN, the terminal TE1 converts, by the RF unit 1c, the beam search signal to a BB signal and detects, by the beam search unit 1w, the beam direction of AP.

After receiving a signal that has been transmitted from AP1, the terminal TE1 checks, by the error check unit 1r, whether or not there is an error. This error check is performed, for example, using cyclic redundancy check (CRC). If an error has not been detected, the ACK signal generation unit 1s generates an ACK signal that is transmitted to AP1. The terminal TE1 controls, by the beam control unit 1v, the phase of PS such that a beam is directed in a direction toward AP that has been detected by the beam search unit 1w and transmits the ACK signal. If an error has been detected, the AP switching timing control unit it detects an AP switching timing, based on AP switching timing information included in control information that has been transmitted from AP1. The beam direction calculation unit 1u calculates the direction of a beam that is directed by the self terminal TE1 after AP switching, based on beam direction information after AP switching, which is included in the control information that has been transmitted from AP1. If the AP switching timing control unit 1t has determined that a timing at which AP is switched has come, the beam control unit 1v controls the phase of PS such that a beam is directed in the direction that has been calculated by the beam direction calculation unit 1u.

A functional configuration of the terminal TE1 has been representatively described, and a functional configuration of each of the other terminal TE2 to the terminal TE4 is similar to the functional configuration of the terminal TE1. Therefore, common component elements are denoted by the same reference symbol and the illustration and description thereof will be omitted.

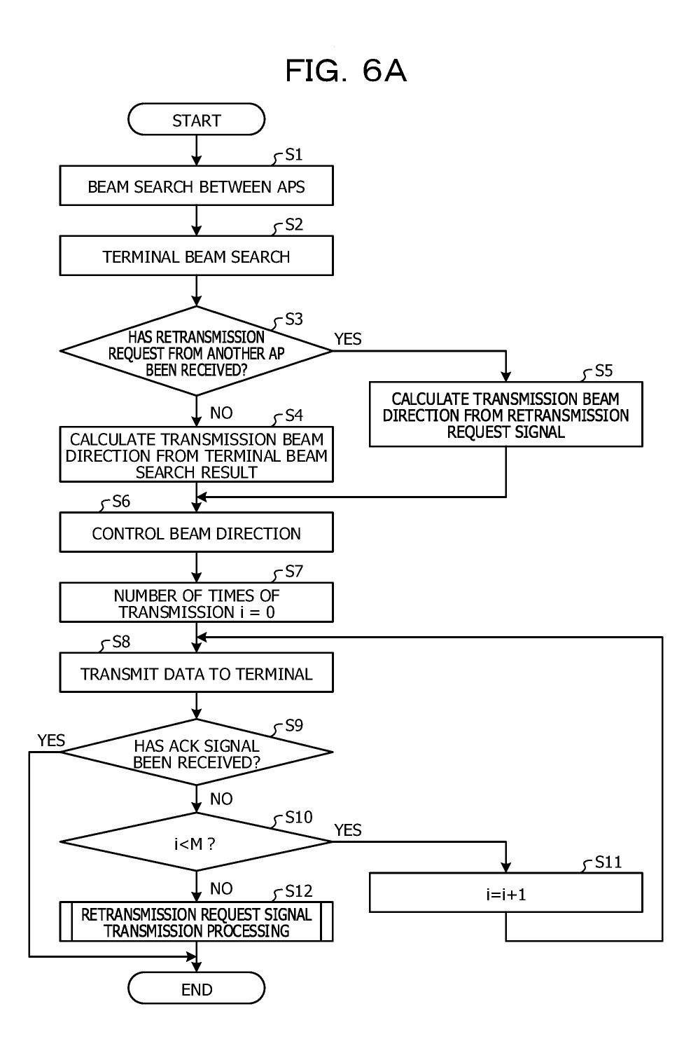

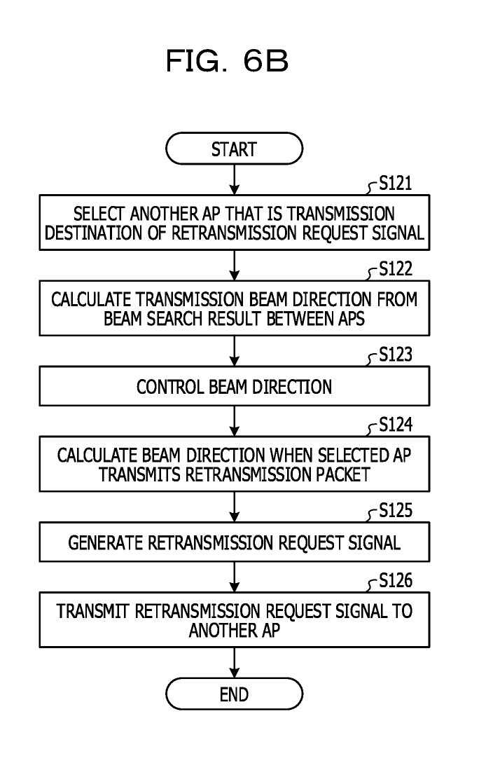

Next an operation will be described. FIG. 6A is a flowchart illustrating an operation of AP1 to APN when the terminal TE1 does not execute BF. First, in S1, each of AP1 to APN performs a beam search between the plurality of AP1 to APN and estimates the locations of the other APs in advance. Similarly, in S2, each of AP1 to APN performs a beam search on each of the terminals TE1 to TE4 and estimates the locations of the terminals TE1 to TE4 in advance. For example, if AP1 has not received a retransmission request signal from another AP (NO in S3), AP1 calculates the beam direction of a signal that is transmitted by the self AP, based on a result of a terminal beam search in S2 (S4). In contrast, for example, if AP1 has received a transmission request signal from another APN (YES in S3), AP1 calculates the beam direction of a signal that is transmitted by the self AP, based on the received retransmission request signal (S5).

In S6, AP1 controls, by phase control of a phase shifter (PS), the beam direction to direct a beam in the beam direction that has been calculated in S4 or S5 above. Next, AP1 resets the number of times of signal transmission i to i=0 (S7) and transmits data, for example, to the terminal TE1 (S8). After the transmission, when AP1 receives an ACK signal (YES in S9), a series of processing is terminated but, if AP1 has not received an ACK signal in a certain time (NO in S9), AP1 determines whether or not the number of times of signal transmission i<the threshold M is satisfied (S10). As a result of the determination, if the number of times of signal transmission i<the threshold M is satisfied (YES in S10), after AP1 increments the number of times of signal transmission i by only one (S11), the processing returns to S8 described above and subsequent processing is executed again. That is, AP1 transmits data to the terminal TE1 again. On the other hand, as a result of the determination in S10 described above, if the number of times of signal transmission i<the threshold M is not satisfied (NO in S10), AP1 determines that the number of times of signal transmission has exceeded an upper limit and requests another AP (for example, AP2) to retransmit data again by executing retransmission request signal transmission processing, which will be described later.

Next, with reference to FIG. 6B, retransmission request signal transmission processing will be described. FIG. 6B is a flowchart illustrating retransmission request signal transmission processing that is executed by AP1 when the terminal TE1 does not execute beam forming (BF). First, in S121, AP1 selects, for example, AP2 as another AP that is to be a transmission destination of a retransmission request signal. Next, AP1 calculates, based on a beam search result of a beam search between AP1 and AP2 in S1 described above, the beam direction of the retransmission request signal that is transmitted by the self AP (S122). In S123, AP1 controls the beam direction to direct a beam in the beam direction that has been calculated in S122 described above. Next, AP1 calculates a beam direction when the transmission destination AP (AP2) that has been selected in S121 transmits a retransmission packet to the terminal TE1 (S124). In S125, AP1 generates a retransmission request signal that includes the calculation result. Then, AP1 transmits the generated retransmission request signal to another AP2 (S126).

Note that, in S121 described above, when AP1 selects another AP, the number of APs that are selected may be some other number than one. That is, AP1 may be configured to select a plurality of APs as the transmission destination APs of a retransmission request signal and transmit the retransmission request signal simultaneously to the plurality of APs (for example, AP2 to AP4). In this case, the plurality of APs simultaneously transmits a retransmission packet to the terminal TE1. Thus, by performing retransmission request signal transmission processing a small number of times, desired data may be caused to reach the terminal TE1 more reliably.

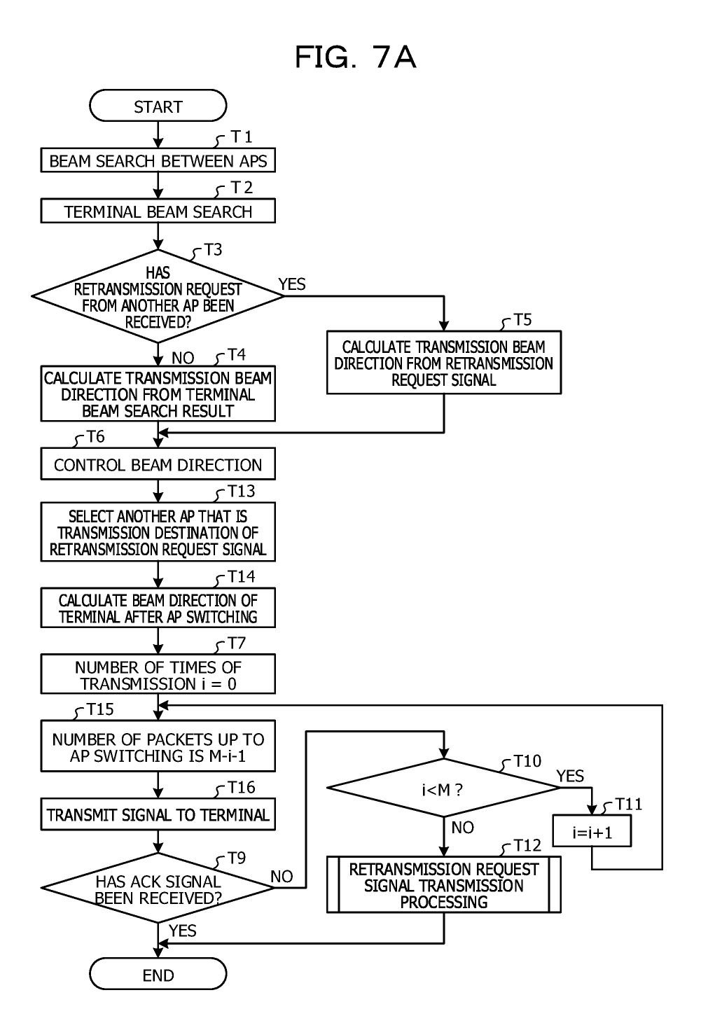

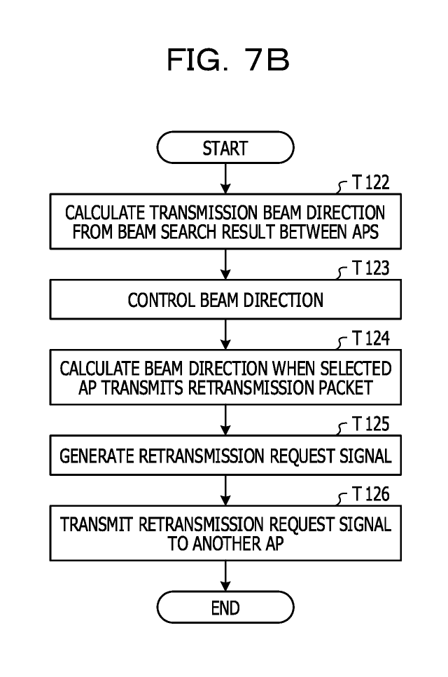

The description above is premised on an assumption that the terminal TE1 does not execute beam forming (BF), and subsequently, an operation when the terminal TE1 executes BF will be described with focus on a different point. FIG. 7A is a flowchart illustrating an operation of AP when the terminal TE1 executes BF. In FIG. 7A, the operation includes a plurality of steps similar to steps of processing illustrated in FIG. 6A which has been referred to in the description of an operation when BF is not executed, and therefore, common steps will be denoted by reference symbols that have the same end character and the detailed description thereof will be omitted. Specifically, processing of each of Steps T1 to T7 and T9 to T12 in FIG. 7A corresponds to the processing of the corresponding one of Steps S1 to S7 and S9 to S12 illustrated in FIG. 6A.

When the terminal TE1 executes BF, it is preferable to notify, after switching AP, the terminal TE1 of a direction to which the terminal TE1 directs a beam. Thus, in T13, in advance of data transmission to the terminal TE1, AP1 selects, for example, AP2 as another AP that is to be a transmission destination of a retransmission request signal. Next, AP1 calculates the beam direction of the terminal TE1 after being switched to the transmission destination AP2 that has been selected in T13 (T14). Specifically, AP1 calculates the beam direction of the terminal TE1 after AP switching from the beam direction between self AP1 that is a switching source and the terminal TE1 and the beam direction between self AP1 and switching destination AP2.

When the terminal TE1 executes BF, it is preferable to also notify the terminal TE1 of a timing at which AP is switched. Thus, in T15, AP1 sets M−i−1 as the number of packets up to a timing at which AP is switched to AP2. Note that this embodiment has described an aspect in which AP1 determines, based on the number of transmission packets, an AP switching timing and notifies the AP switching timing but, for example, an elapsed time since head packet transmission or the like may be used.

In T16, AP1 inserts each of information of the beam direction of the terminal TE1 after AP switching and information of AP switching timing in control information of a signal (a packet) that is transmitted to the terminal TE1 and thus transmits each of the pieces of information. Subsequent processing is similar to processing of S9 to S12 in FIG. 6A, and therefore, the detailed description thereof will be omitted but, if AP1 has received an ACK signal from the terminal TE1 (YES in T9), AP1 determines that the transmission is correctly completed. If AP1 has not received an ACK signal (NO in T9), AP1 transmits the above-described signal to the terminal TE1 a predetermined number of times, that is, M times, until AP1 receives the ACK signal. Then, if, even after AP1 has transmitted the above-described signal M times, AP1 has not received the ACK signal, AP1 transmits a retransmission request signal to another AP (for example, AP2) (T12).

FIG. 7B is a flowchart illustrating retransmission request signal transmission processing that is executed by AP when the terminal TE1 executes BF. FIG. 7B is similar to FIG. 6B which has been referred to in the description of an operation when BF is not executed, except a point that retransmission request signal transmission processing does not include selection processing of selecting another AP. Therefore, common steps are denoted by reference symbols that have the same end character and the description thereof will be omitted. Specifically, processing of each of Steps T122 to T126 in FIG. 7B corresponds to the processing of the corresponding one of Steps S122 to S126 illustrated in FIG. 6B.

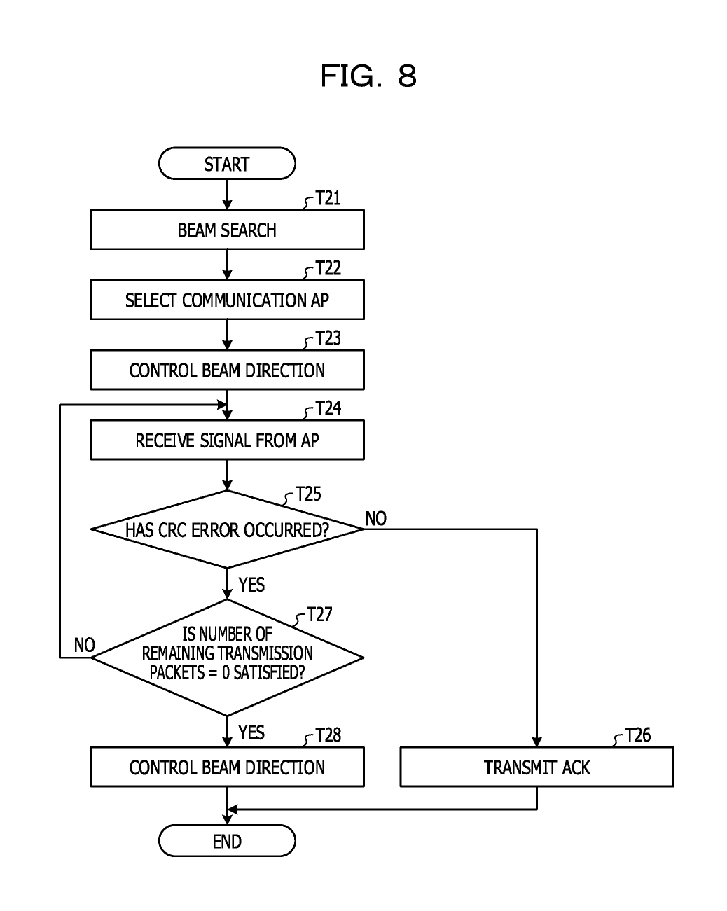

FIG. 8 is a flowchart illustrating an operation of the terminal TE1 when the terminal TE1 executes beam forming (BF). When BF is executed also in the terminal TE1, the terminal TE1 detects in which direction AP that is a data transmission source is located when viewed from the self terminal, and therefore, the terminal TE1 performs a beam search before a communication is performed (T21) and thus selects AP that is a communication partner (T22). In T23, the terminal TE1 controls a beam direction such that a beam is directed in a direction toward AP (for example, AP1) that has been selected in T22. When the terminal TE1 receives a signal that has been transmitted from AP1 (T24), the terminal TE1 decodes a packet and checks whether or not a CRC error has occurred (T25).

As a result of the above-described check, if a CRC error has not occurred (NO in T25), the terminal TE1 transmits an ACK signal to AP1 (T26). In contrast, if the occurrence of a CRC error has been detected (YES in T25), the terminal TE1 determines, based on the AP switching timing information included in the above-described control information of the reception signal, whether or not a retransmission packet is transmitted from another AP2 (T27). Note that, although, in FIG. 8, the terminal TE1 uses the number of remaining transmission packets as the AP switching timing information, for example, an elapsed time since head packet reception or the like may be used.

As a result of the above-described determination, when the AP switching timing comes and if it has been determined that a retransmission packet is transmitted from another AP2 (YES in T27), the terminal TE1 controls the beam direction of the self terminal (T28). Specifically, the terminal TE1 calculates a beam direction (a direction in which another AP2 is expected to transmit a signal) in which the self terminal receives the retransmission packet that is transmitted from another AP2, based on the beam direction information of the terminal TE1 after AP switching, which is included in the control information of the reception signal, and controls the beam direction such that the beam direction fits the calculated beam direction. On the other hand, as a result of the above-described determination, if the AP switching timing has not been reached and it is determined that a packet is transmitted from AP1 before switching (NO in T27), the process returns to T24 described above and the subsequent processing is executed again.

Note that, as described above, there may be a case where, when the terminal TE1 does not perform beam control of BF or the like, a series of processing of T21 to T28 described above is not executed.

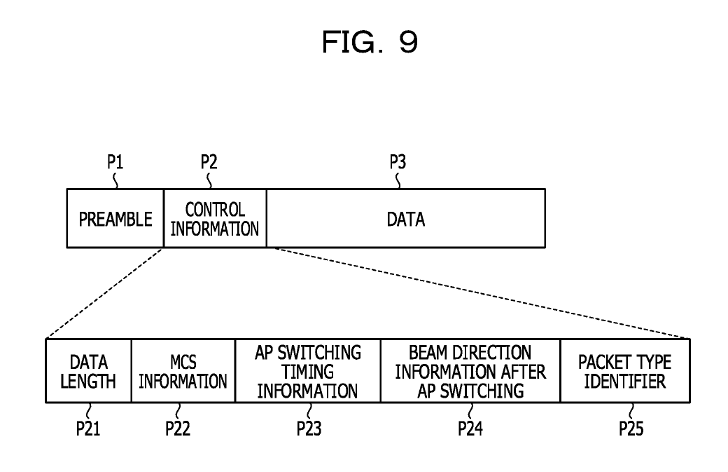

FIG. 9 is a diagram illustrating an example of a format of a packet P that is transmitted to the terminal TE1 by AP1 in T16 described above. As illustrated in FIG. 9, the packet P includes a preamble P1, control information P2, and data P3. Furthermore, the control information P2 includes a data length P21, modulation and coding scheme (MCS) information P22, AP switching timing information P23, post-AP switching beam direction information P24, and a packet type identifier P25. The terminal TE1 refers to the AP switching timing information P23 included in the control information P2 and calculates a timing at which a retransmission packet is transmitted from AP2 that is a switching destination. Specific examples of the AP switching timing information P23 include an absolute time, a relative time, the number of remaining transmission packets, or the like. Also, the terminal TE1 refers to the post-AP switching beam direction information P24 included in the control information P2 and calculates the beam direction of the self terminal when a transmission packet is transmitted from AP2 that is a switching destination. Note that the terminal TE1 determines the type of a received packet with reference to the packet type identifier P25. Examples of the type of the packet include a data packet, a control packet, a retransmission request packet, or the like.

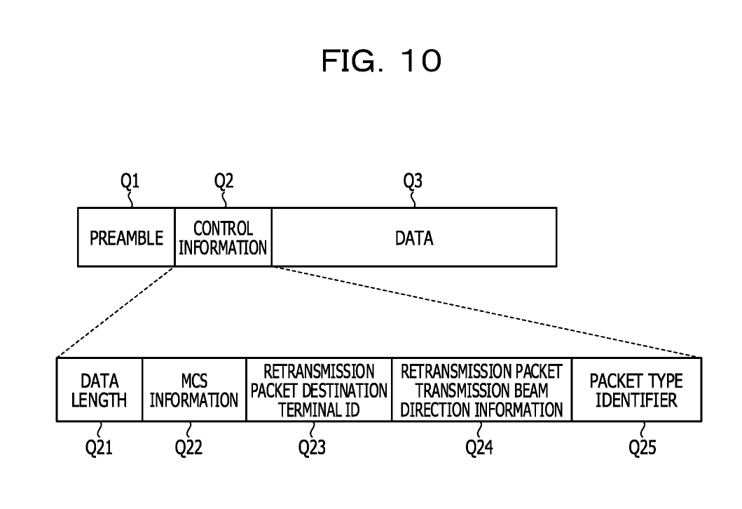

FIG. 10 is a diagram illustrating an example of a format of a retransmission request packet Q that is transmitted by AP1 to another AP in T12 described above. As illustrated in FIG. 10, the packet Q includes a preamble Q1, control information Q2, and data Q3. Furthermore, the control information Q2 includes a data length Q21, MCS information Q22, a retransmission packet destination terminal ID Q23, retransmission packet transmission beam direction information Q24, and a packet type identifier Q25. Another AP2 acquires an ID of a terminal (for example, the terminal TE1) which is to be a transmission destination of a retransmission packet from the retransmission packet destination terminal ID Q23 included in the control information Q2. Also, another AP2 refers to the retransmission packet transmission beam direction information Q24 included in the control information Q2 and calculates the beam direction of self AP2 when self AP2 transmits a retransmission packet. Note that, with reference to the packet type identifier Q25, AP2 determines the type of a received packet. Examples of the type of the packet include a data packet, a control packet, a retransmission request packet, or the like.

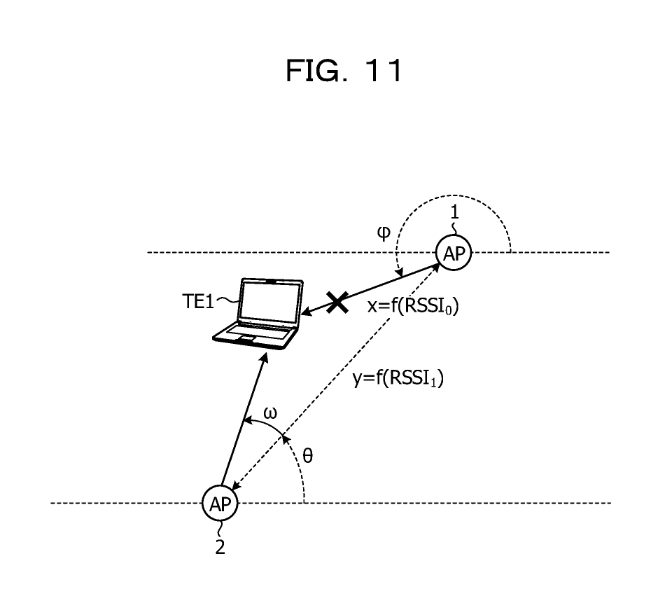

Next, with reference to FIG. 11, a method for calculating the beam direction of a self terminal after AP switching, which is performed by the terminal TE1, will be described. FIG. 11 is a diagram illustrating a method for calculating the beam direction of the terminal TE1 after AP switching. In FIG. 11, an angle of the terminal TE1-AP1-AP2 is θ−φ+180 degrees. Assuming that the angle of AP1-AP2-the terminal TE1 is ω, the total sum of the interior angles of a triangle is 180 degrees, and therefore, an angle φ of AP1-the terminal TE1-AP2 may be calculated in accordance with Expression 5 as follows.

[Expression 5]

ω+θ−ϕ+180+φ=180

∴φ=ϕ−ω−θ (5)

As has been described above, the wireless communication system 100 includes AP1, AP2, and the terminal TE1. AP1 includes the communication cutoff detection unit 1i, the retransmission AP determination unit 1k, the retransmission beam direction calculation unit 1e, and the packet generation unit 1f. The communication cutoff detection unit 1i detects a cutoff of a communication between AP1 and the terminal TE1. When a cutoff of a communication is detected by the communication cutoff detection unit 1i, the retransmission AP determination unit 1k selects AP2. The retransmission beam direction calculation unit 1e calculates a communication direction (for example, a beam direction) when AP2 that has been selected by the retransmission AP determination unit 1k transmits (for example, retransmits) data (for example, a packet) to the terminal TE1. The packet generation unit 1f transmits, to AP2, a transmission request for transmitting the above-described data including the communication direction that has been calculated by the retransmission beam direction calculation unit 1e. AP2 includes RF1c and the packet generation unit 1f. RF1c receives the transmission request for transmitting the above-described data. When the packet generation unit 1f receives, by RF1c, the transmission request for transmitting the above-described data, the packet generation unit 1f transmits the above-described data to the terminal TE1 in accordance with the communication direction. The terminal TE1 includes RF1c. RF1c receives the above-described data that has been transmitted by the packet generation unit 1f.

The wireless communication system 100 controls a plurality of antennas using a super high-frequency band, such as a millimeter wave band or the like and, if, when the wireless communication system 100 performs a wireless communication while controlling a beam direction, it is determined that a communication between AP1 and the terminal TE1 is cut off, the wireless communication system 100 performs autonomous control between APs such that a signal is transmitted from a different AP2 to the terminal TE1. Thus, even when a wireless communication path is cut off by a human body or a shielding object, the wireless communication system 100 is enabled to immediately recover a communication. As a result, reduction in throughput in the wireless communication system 100 may be reduced.

AP1 may be configured to further include the terminal beam direction information generation unit 1q that calculates a communication direction when the terminal TE1 receives the above-described data from AP2 and the packet generation unit 1f that notifies the terminal TE1 of the calculated communication direction. In the above-described aspect, the RF unit 1c of the terminal TE1 may be configured to receive the above-described data from AP2 in accordance with the communication direction that has been notified from AP1. Thus, the terminal TE1 is enabled to receive, even when the terminal TE1 that receives data is a terminal that executes BF, data that has been retransmitted from switching destination AP2, and therefore, an advantage that a system load accompanied with data retransmission is reduced may be achieved also in a system in which a BF execution terminal exists.

AP1 may be configured to further include the RF unit 1c that transmits the communication direction of the terminal TE1 after switching AP that transmits data to the terminal TE1 (for example, in which direction another AP is located when viewed from the terminal TE1) and an AP switching timing to the terminal TE1 in prior to the switching. In this case, AP1 may be configured to transmit, in addition to information of the communication direction of the terminal TE1 after switching and information of the AP switching timing, identification information of AP (for example, AP2) which is a switching destination to the terminal TEL

In the above-described aspect, the terminal TE1 may be configured to include the RF unit 1c that receives, from AP1 that is a switching source, the communication direction of the terminal TE1 after switching AP that transmits data to the terminal TE1 and the AP switching timing and the beam control unit 1v that performs control in which data that is transmitted by AP2 that is a switching destination from the communication direction is received at the received switching timing. Thus, the terminal TE1 is enabled to immediately recover, with the AP switching timing as a trigger, a previous data communication by autonomously starting control of the beam direction. Therefore, the terminal TE1 is enabled to reliably and quickly receive, even when AP is switched in association with a cutoff of a communication with AP1, a retransmission packet form AP2 that is a switching destination.

Furthermore, the retransmission AP determination unit 1k of AP1 may be configured to select, based on the communication direction at the time of a communication between AP1 and the terminal TE1 and the communication direction at the time of a communication between AP1 and AP2, AP (for example, AP5) the communication direction of which is a communication direction that differs (for example, differs most or is opposite) from a direction from AP1 to the terminal TE1 as AP that is to be a transmission destination of a transmission request for transmitting the above-described data. That is, when a communication between AP1 and the terminal TE1 is cut off, it is highly likely that a human body or a shielding object exists between AP1 and the terminal TE1, and therefore, AP1 selects AP that is located in an opposite side to AP1 with the terminal TE1 interposed therebetween as a transmitting main entity of a retransmission packet. Thus, an influence of the human body and the shielding object on a communication between AP and the terminal TE1 is reduced. Therefore, a retransmission packet may be caused to reach the terminal TE1 more reliably. Also, when a retransmission packet does not reach the terminal TE1, it is less desired to search for AP again.

Note that, in the above-described embodiment, the retransmission AP determination unit 1k of AP1 selects AP at an opposite side or the like as AP that transmits a retransmission packet. However, the retransmission AP determination unit 1k may be configured to select AP that is located at a smallest distance or a predetermined distance or less from the terminal TE1 that is a communication partner, AP that has a largest free resource or a predetermined free resource or more, or AP that is coupled to a smallest number or a predetermined number or less of terminals TE. Also, a trigger with which AP1 determines a retransmission request for another AP is not limited to detection of a cutoff of a communication but may be, for example, a timing at which, in AP that is a switching source, the number of terminals TE to which AP is coupled is a predetermined value or more. As another option, a configuration in which, when the free resource is a predetermined value or less, or when the distance from the terminal TE1 is a predetermined value or more, a retransmission request to another AP is issued may be employed.

Furthermore, although, in the above-described embodiment, as the terminal TE1, a smartphone is assumed, according to the present disclosure, the terminal TE1 is not limited to a smartphone, but the present disclosure may be applied to various communication devices, such as a mobile phone, a personal digital assistant (PDA), or the like, which are capable of measuring wireless communication quality. Also, as for the wireless communication quality, not only the RSSI value but also a signal to interference ratio (SIR) value, a signal to interference and noise ratio (SINR) value, a reference signal received power (RSRP) value, a reference signal received quality (RSRQ) value, or the like may be used. As another option, channel state information (CSI), such as a channel quality indicator (CQI), a precoding matrix indicator (PMI), a rank indicator (RI), a layer indicator (LI), or the like may be used.

Also, each component element of AP1 may not be physically configured as illustrated in the drawings. That is, specific embodiments of disintegration and integration of each unit are not limited to those illustrated in the drawings, and all or some of the units may be disintegrated/integrated functionally or physically in an arbitrary unit 1n accordance with various loads, use conditions, and the like. For example, the packet generation unit 1f and the retransmission request packet generation unit 1h, or the AP beam search unit 1j and the terminal beam search unit 1m may be integrated as a single component element. On the other hand, the packet generation unit 1f may be disintegrated, for example, such that a part that generates a packet used for transmitting AP switching timing information and a part that generates a packet used for transmitting terminal beam direction information after AP switching are separated. Furthermore, a storage device, such as the memory 19 or the like, may be coupled as an external device of AP1 or the terminal TE1 to AP1 or the terminal TE1 via a network or a cable.

Furthermore, not only a configuration in which a component element when the terminal TE1 does not execute BF and a component element when the terminal TE1 executes BF are separately provided for each AP but also a configuration in which a single AP1 includes a component element when the terminal TE1 does not execute BF and a component element when the terminal TE1 executes BF together may be employed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
a first communication device; and
a second communication device,
wherein the first communication device includes:
a first memory, and
a first processor coupled to the first memory and configured to:
detect that a first communication between the first communication device and a terminal device has been cut off,
determine a direction from the second communication device to the terminal device when the first communication has been cut off, and
transmit, to the second communication device, direction information indicating the direction and a transmission request requesting a transmission of data, and
the second communication device includes:
a second memory, and
a second processor coupled to the second memory and configured to:
receive the direction information and the transmission request, and
transmit the data to the terminal device based on the direction information and the transmission request.

2. The communication system according to claim 1,
wherein the second processor is configured to adjust a beam direction to the terminal device based on the direction information to transmit the data to the terminal device.

3. The communication system according to claim 1,
wherein the first processor is configured to transmit the direction information to the terminal device.

4. The communication system according to claim 2,
wherein the first processor is configured to transmit to the terminal device a timing at which the first communication between the terminal device and the first communication device is switched to a second communication between the terminal device and the second communication device.

5. The communication system according to claim 1, wherein
the first processor is configured to determine the direction based on a second direction from the first communication device to the terminal device and a third direction from the first communication device to the second communication device, and
the second direction is a different direction from the direction.

6. The communication system according to claim 5, wherein the first processor is configured to:
perform a beam search for the second communication device to determine a beam direction, and
determine the third direction and a distance from the first communication device to the second communication device based on the beam search.

7. The communication system according to claim 1,
wherein the transmission request includes data information indicating the data to be transmitted to the terminal device.

8. The communication system according to claim 1, wherein
the first processor is configured to
determine a first location of the terminal device and a second location of the second communication device,
determine the direction based on a positional relationship between the second communication device and the terminal device which is determined by using the first location and the second location.

9. The communication system according to claim 8, wherein
the first processor is configured to execute a second beam search to determine the first location.

10. A communication device comprising:
a memory, and
a processor coupled to the memory and configured to:
detect that a first communication between the communication device and a terminal device has been cut off,
determine a direction from another communication device to the terminal device when the first communication has been cut off, and
transmit, to the another communication device, direction information indicating the direction and a transmission request requesting a transmission of data, wherein
the another communication device transmits the data to the terminal device based on the direction information and the transmission request.

11. The communication device according to claim 10,
wherein the second communication device is configured to adjust a beam direction to the terminal device based on the direction information to transmit the data to the terminal device.

12. The communication device according to claim 10,
wherein the processor is configured to transmit the direction information to the terminal device.

13. The communication device according to claim 11,
wherein the processor is configured to transmit to the terminal device a timing at which the first communication between the terminal device and the communication device is switched to a second communication between the terminal device and the another communication device.

14. The communication device according to claim 10, wherein
the processor is configured to determine the direction based on a second direction from the first communication device to the terminal device and a third direction from the first communication device to the second communication device, and
the second direction is a different direction from the direction.

15. The communication device according to claim 14, wherein the processor is configured to:
perform a beam search for the another communication device to determine a beam direction, and
determine the third direction and a distance from the communication device to the another communication device based on the beam search.

16. The communication device according to claim 10,
wherein the transmission request includes data information indicating the data to be transmitted to the terminal device.

17. The communication device according to claim 10, wherein
the processor is configured to:
determine a first location of the terminal device and a second location of the another communication device,
determine the direction based on a positional relationship between the another communication device and the terminal device which is determined by using the first location and the second location.

18. The communication device according to claim 17, wherein
the processor is configured to execute a second beam search to determine the first location.

19. A method comprising:
detecting, by a first communication device, that a first communication between the first communication device and a terminal device has been cut off,
determining, by the first communication device, a direction from a second communication device to the terminal device when the first communication has been cut off;
transmitting, from the first communication device to the second communication device, direction information indicating the direction and a transmission request requesting a transmission of data;
receiving, by the second communication device, the direction information and the transmission request; and
transmitting, by the second communication device, the data to the terminal device based on the direction information and the transmission request.

20. The method according to claim 19, further comprising:
adjusting, by the second communication device, a beam direction to the terminal device based on the direction information to transmit the data to the terminal device.
